(19) United States
(12) Patent Application Publication
(10) Pub. No.: US 2014/0191725 A1
(43) Pub. Date: Jul. 10, 2014

(54) METHOD AND DEVICE FOR EQUILIBRATING ELECTRIC ACCUMULATOR BATTERIES

(71) Applicants: Lionel Cordesses, Montigny-Le-Bretonneux (FR); Ana-Lucia Driemeyer-Franco, Montigny-Le-Bretonneux (FR); Daniel Chatroux, Teche (FR)

(72) Inventors: Lionel Cordesses, Montigny-Le-Bretonneux (FR); Ana-Lucia Driemeyer-Franco, Montigny-Le-Bretonneux (FR); Daniel Chatroux, Teche (FR)

(73) Assignee: RENAULT s.a.s., Boulogne-Billancourt (FR)

(21) Appl. No.: 14/234,734

(22) PCT Filed: Jul. 12, 2012
(86) PCT No.: PCT/FR2012/051656

§ 371 Date: Feb. 28, 2014

(30) Foreign Application Priority Data
Jul. 25, 2011 (FR) 1156742

(51) Int. Cl. H02J 7/00

(52) U.S. Cl. CPC H02J 7/0068
USPC 320/118

(57) ABSTRACT

A method and a device for equilibrating an accumulator battery including a battery including accumulators connected together in series and in which a charging current charges the accumulators, the accumulators exhibiting a maximum charge state. The accumulators are charged during a charging to increase the charge of the accumulators up to their maximum charge state. The charging includes in order: a) feeding the accumulators in series with the charge current at a charging value until one of the accumulators of the battery reaches the maximum charge state; b) meanwhile the one of the accumulators is coupled to terminals of a corresponding resistor, while the charge current is simultaneously reduced; and, then c) returning to a).

The present invention relates to a method and a device for balancing electrical accumulator batteries.

An envisaged field of application is notably, but not exclusively, the management of the charge of lithium-ion batteries. This type of battery has a plurality of electrical accumulators, or cells, including a rechargeable electrochemical system intended to provide a nominal voltage.

The charging or discharging of these accumulators translates respectively into an increase or decrease in the voltage across the terminals of the accumulator. The accumulator is in the charged, or else discharged, state when it has reached a voltage level defined by the electrochemical equilibrium of the system. In a circuit including a plurality of accumulators in series, in one and the same current value flows through all the accumulators. Thus, the level of charging or discharging of the accumulators depends on the intrinsic characteristics of said accumulators, namely, the intrinsic capacitance and the parasitic internal resistances of the electrolyte and/or of the electrodes of the electrochemical system. Consequently, voltage differences between the accumulators can appear due to disparities in manufacture and ageing.

Furthermore, the accumulators of one and the same electrochemical system exhibit a given maximum charge state that it is advisable not to exceed when charging the accumulator battery, at risk of damaging them.

Now, in view of the foregoing, when charging the accumulator battery, not all the accumulators reach the given maximum charge at the same time. Thus, it is necessary to provide individual charging for each of the accumulators of an accumulator battery, in such a way that the charging is stopped for each of them when the given maximum charge is reached, and consequently to balance the charge of the accumulators.

It will be noted that the problem of discharging is just as acute. There again, not all the accumulators of one and the same battery attain their minimum charge level simultaneously.

Reference can notably be made to the document U.S. Pat. No. 6,377,024, which discloses a device including a charger for each accumulator of one and the same battery.

The device described in this document takes into account the maximum and minimum charge thresholds of each of the accumulators to start and then stop the individual charging of the latter.

A drawback of this device lies in its cost, since it requires the use of as many chargers as there are accumulators for said battery.

Thus, a problem that arises and that the present invention aims to resolve is that of providing a balancing method and a balancing device that are cheap.

With this aim, the present invention proposes, according to a first subject, a method for balancing an electrical accumulator battery, said method being of the type according to which firstly an electrical accumulator battery comprising accumulators connected together in series and secondly a charge current exhibiting a charging value for charging said accumulators are provided, said accumulators exhibiting a maximum charge state, and said accumulators are charged during a charging step so as to increase the charge of said accumulators up to their maximum charge state. According to the invention, said charging step comprises the following sub-steps in order: a) said accumulators are fed in series with said charge current at said charging value until one of said accumulators of said battery reaches said maximum charge state; b) during a coupling period said one of said accumulators is coupled to the terminals of a corresponding discharging element in such a way as to discharge said one of said accumulators, while said charge current is simultaneously lowered to an equilibrium value; and c) the process returns to sub-step a) after a time period less than or equal to said coupling period.

Thus, a characteristic of the invention lies in the feeding of all the series-connected accumulators with a single charging device as will be explained in the rest of the description, and in the placing in parallel, on a discharging element for a predetermined coupling period, of the accumulator that has reached the maximum charge state first. The discharging element is advantageously a resistor. Nonetheless, it can be composed of a device making it possible not to dissipate energy, but to transfer it to other accumulators that have not yet reached the maximum charge state.

In this way, during the coupling period, the charge of this accumulator is lowered, then after this coupling period all the accumulators of said battery are charged again until an accumulator reaches the maximum charge state again. In this way, as the cycle repeats itself, all the accumulators of the accumulator battery converge toward the maximum charge state. Additionally, their respective charge state oscillates between the maximum charge state and the charge state to which a balanced accumulator can fall again during said coupling period. Thus, all the accumulators are successively charged and balanced with only a single charging device, which is much less expensive.

In a particularly advantageous mode of implementation of the invention, in step b), the discharging element, or the corresponding resistor, is passed through by a balancing current and said charge current is lowered to a value less than or equal to said balancing current. In this way, the charging of the other accumulators is not totally interrupted. When the charge current is at a value equivalent to the balancing current, it is then driven in “proportional mode” and requires an additional driving element. Advantageously, said charge current is lowered to a nil value, and the driving is implemented in “all-or-nothing mode”, which substantially reduces the charging speed of the accumulator battery but, on the other hand, simplifies the assembly.

In a particularly, advantageous mode of implementation of the invention, a higher charge state is defined, said higher charge state being below said maximum charge state, and furthermore, in substep b), the accumulators whose charge state lies between said higher charge state and said maximum charge state are coupled to corresponding discharging elements in such a way as to discharge them. This higher charge state, although below the maximum charge state, is very close to it. In this way, not only is the charge of the most charged accumulator lowered, but also simultaneously the charge of those whose charge state is in the vicinity of said maximum charge state. In this way, the following cycle is longer and consequently, over the cycles, the charging speed of the accumulators of the battery is faster.

Furthermore, preferably, in substep c), the process returns to sub-step a) if, and only if, at least one accumulator exhibits a charge state below said higher charge state. In this way, the charging of the accumulators of the battery can be interrupted when all the accumulators exhibit a charge state lying between the maximum charge state and the higher charge state. Thus, the feeding and the balancing of the accumulators are interrupted when this is no longer necessary.

According to another subject, the present invention proposes a balancing device intended for charging an electrical accumulator battery, said electrical accumulator battery comprising accumulators connected together in series, said accumulators exhibiting a maximum charge state, said balancing device comprising charging means for providing a charge current exhibiting a charging value, said charge current being intended to charge said accumulators during a charging step so as to increase the charge of said accumulators up to their maximum charge state. According to the invention, the balancing device comprises: control means and monitoring means, for controlling said charging means so that they feed said accumulators in series with said charge current at said charging value until said monitoring means monitor one of said accumulators of said battery at its maximum charge state; coupling means able to be controlled by said control means to couple, during a coupling period, said one of said accumulators to the terminals of a corresponding discharging element in such a way as to discharge said one of said accumulators, while said control means simultaneously lower said charge current; and said control means are able to control the feeding of said accumulators with said charge current at said charging value, after a time period less than or equal to said coupling period. In the rest of the description, the mode of operation of the balancing device according to the invention will be explained in more detail.

Moreover, said coupling means comprise corresponding switches and discharging elements, for each of said accumulators, said switches being linked to said control means. Preferably, the corresponding discharging elements are resistors.

Advantageously, said monitoring means comprise first monitoring means linked to said control means, for each of said accumulators. Thus, the first monitoring means communicate the charge state of the accumulators to the control means, and, as soon as one of the accumulators reaches the maximum charge state, the control means control the switch to connect the corresponding discharging element or, for example, the resistor to the terminals of said one of the accumulators.

In a particularly advantageous mode of implementation of the invention, said monitoring means furthermore comprise second monitoring means for each of said accumulators, said second monitoring means being able to monitor a higher charge state, said higher charge state being below said maximum charge state. Owing to the first and second monitoring means, the accumulators of said battery are made to converge more quickly toward their maximum charge state.

Preferably, each monitoring means is composed of a voltage comparator. These voltage comparators offer the advantage of being much less expensive than an analog-to-digital converter that allows the precise value of the current to be provided.

Other peculiarities and advantages of the invention will appear on reading the description below of a particular mode of implementation of the invention, given by way of illustration but in non-limiting fashion, with reference to the appended drawings, in which:

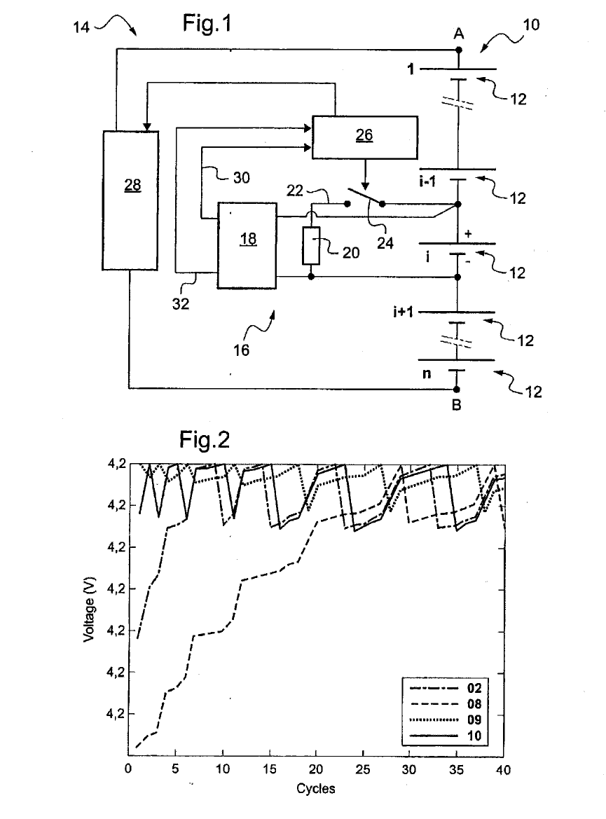

FIG. 1 is a block diagram of a first elementary unit of a balancing device in accordance with the invention, and in a first variant embodiment;

FIG. 2 is a graph illustrating the mode of operation of the balancing device in the first variant embodiment;

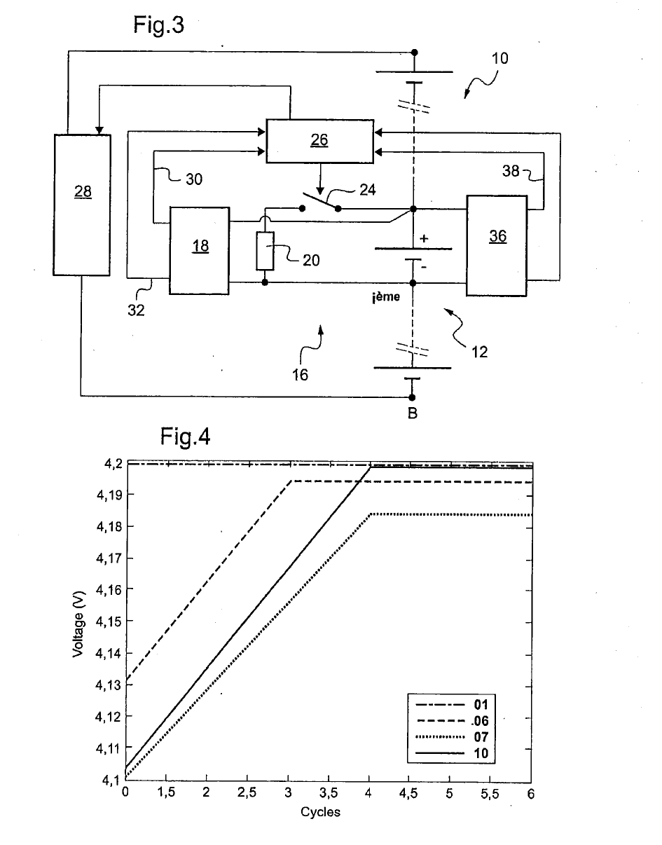

FIG. 3 is a block diagram of a second elementary unit of a balancing device in accordance with the invention, and in a second variant embodiment; and

FIG. 4 is a graph illustrating the mode of operation of the balancing device in the second variant embodiment.

FIG. 1 illustrates a battery 10 of n accumulators 12, or cells, assembled in series, between two terminals A, B as well as a balancing device 14 in a first variant embodiment, which is shown in part. The accumulators 12 are of lithium-ion type, for example. They each exhibit a maximum charge state corresponding, for example, to 3.6 V for a lithium-ion electrochemical system based on iron phosphate, and whose nominal voltage is 3.3 V. It will furthermore be noted that the charging or the discharging of an accumulator corresponds to a high voltage and a low voltage respectively, across the terminals of this accumulator around the nominal voltage. As a consequence, it is possible to measure the charge or else discharge state of an accumulator by monitoring the voltage across its terminals. Moreover, where a lithium-ion-type accumulator based on iron phosphate is concerned, overcharging translates into decomposition of the electrolyte, which reduces its life and can damage the accumulator. Conversely, excessive discharging that brings it to a voltage below 2 V, for example, mainly leads to oxidation of the current collector of the negative electrode when said collector is made of copper, and consequently to a deterioration in the accumulator. As a consequence, it is necessary to balance the accumulators 12 of the battery 10 when the latter is in a charging phase, in order to prevent the accumulators that reach their maximum charge state before the others from deteriorating. It can also be advantageous to prevent the accumulators from discharging below a minimum charge state, as will be explained in the rest of the description.

FIG. 1 shows an elementary balancing unit 16 assembled in parallel with the i^{th} accumulator 12. This elementary balancing unit 16 essentially comprises a first monitor or comparator 18 and a resistor 20 as corresponding discharging element, both coupled to the terminals of the accumulator 12. The resistor 20 is part of a balancing circuit 22 able to be closed by a controllable switch 24, these constituting coupling means.

FIG. 1 also shows, firstly, control elements 26 linked to the controllable switch 24 and to the first comparator 18, and secondly a charger 28 connected to the two terminals A, B of the battery 10, said charger itself also being linked to the control elements 26. The control elements 26 comprise, for example, a microcontroller: The first comparator 18 is linked to the control elements 26 by both a first connection 30, which is intended to transmit a higher threshold signal when the maximum charge state, for example 3.6 V, is reached, and a second connection 32 which is intended to transmit a lower threshold signal when the maximum discharge state, for example 2 V, is reached.

Each of the accumulators 12 of the battery 10 is equipped with elementary balancing units 16 assembled in parallel, while the balancing device 14 has a single charger 28 and the single control elements 26 to which all the elementary balancing units 16 are linked.

The mode of operation of the balancing device aims to charge all the accumulators 12 of the battery 10 in series, with the single charger 28, and the individual charge states of which are different, without any of these accumulators 12 exceeding the maximum charge state.

The method of balancing in accordance with the invention will be described below in this first variant embodiment.

Thus, in a first step, the control elements 26 control the charger 28 so that it feeds the battery 10 of accumulators 12 with a charge current of a given charging value. Thus, all the accumulators 12 receive an identical charge current, whereas their own charge state is not necessarily equivalent and, in addition, their charge capacitance is not equivalent either. Thus, during charging, one of the accumulators 12 necessarily reaches the maximum charge state before the others. As soon as this accumulator 12 reaches its maximum charge state, for example the in FIG. 1, the first comparator 18, by way of its first connection 30, transmits a higher threshold signal to the control elements 26. On receiving this signal, the microcontroller 26 simultaneously controls the switch 24 and the closing of the circuit 22, and the lowering of the charge current. This coupling operation is pre-programmed for a given coupling period. During this step, the accumulator 12 discharges across the terminals of the resistor 20, for example between 1/10 and 1/100 of the maximum charge state, while the charge current is lowered in such a way that other accumulators 12 do not reach their own maximum charge state during this coupling period.

In a first mode of implementation, called “all or nothing”, the charge current is brought to zero during this coupling period, which simplifies the assembly of the device and above all makes it possible to prevent another accumulator from reaching its maximum charge state, notably when the coupling period is relatively long. In a second mode of implementation, called “proportional”, the charge current is brought to a value equivalent to the value of the balancing current that passes through the resistor.

As soon as the coupling period has expired, the microcontroller 26 controls the opening of the circuit 22 and the charger 28 so that the latter returns to said given charging value.

Thus, the accumulators 12 are successively charged so as to be brought to a charge state in the vicinity of their maximum charge state.

The reader is referred to FIG. 2, showing a first graph illustrating the progression of the charge state of four of the accumulators of a battery, which battery comprises ten accumulators, as a function of the charging cycles. The maximum charge state is 4.2 V here. Thus, it can be observed that accumulator No 9 is in its maximum charge state, 4.2 V, at the beginning of the application of the method. Accumulator No 10 is also close to the maximum charge state, while accumulator No 2 is in a charge state corresponding to 4.12 V and the accumulator No 8 is at 4.06 V.

Thus, when the battery charging begins, the accumulator No 9 reaches the first maximum charge state. Thus, it is partly discharged while the other accumulators continue either to be charged during the coupling periods, in proportional mode, or not to be charged during this periods, in all or nothing mode. The accumulator No 10 is the second to reach the maximum charge state. It is in turn partly discharged during the coupling period. Thus, accumulators Nos 9 and 10, which have already reached their maximum charge state, oscillate between their maximum charge state and their charge state after coupling to the resistor during the coupling period, while the other accumulators Nos 2 and 8 converge toward their maximum charge state. The accumulator No 2 reaches it toward the seventh cycle, while No 8 reaches it toward the 30^{th} cycle.

Thus, the balancing is carried out from charge to charge in the manner of a sampled system, the sampling period of which corresponds to the coupling period. When all the accumulators have reached their maximum charge state, the charge states of the accumulators, or the corresponding voltages, oscillate between the maximum charge state and the charge state to which a balanced accumulator falls again during the coupling period.

Moreover, owing to the second connection 32 intended for transmitting a lower threshold signal when the maximum discharge state, for example 2 V, is reached, the microcontroller 26 controls the charger 28. In this way, no accumulator can have its charge state fall below a certain threshold, which would run the risk of damaging the accumulator.

In a second variant embodiment of the invention, illustrated in FIG. 3, the elementary balancing unit 16 that is re-encountered furthermore has a second monitor, or comparator 36, also assembled in parallel on the accumulator 12 and linked to the microcontroller 26. The whole balancing device is identical to that of the preceding variant embodiment, and all the elementary balancing units 16 have a second comparator 36. This second comparator 36 is linked to the control elements 26 by a third connection 38 intended for transmitting a threshold signal when a higher charge state, in this case 3.5 V, is reached. Thus, the higher charge state is substantially below the maximum charge state.

The mode of operation of the balancing device in this second variant embodiment will now be described.

Thus, in the same first operating step, the control elements 26 control the charger 28 to feed the battery 10 of accumulators 12 with a charge current of a given charging value. As soon as an accumulator 12 reaches its maximum charge state, in this case the i^{th} in FIG. 3, the first comparator 18, by way of its first connection 30, always transmits a higher threshold single to the control elements 26. On receiving this signal, the microcontroller 26 controls not only the switch 24 and the simultaneous lowering of the charge current for the i^{th} accumulator 12, but also that for all the accumulators 12 for which the second comparator 36 will also have transmitted a threshold crossing signal, i.e. for which the charge state corresponds to a voltage lying between 3.5 V and 3.6 V. Thus, the accumulators of the battery 10 whose charge state is in the vicinity of the maximum charge state will also be partly discharged. This allows faster balancing of the accumulators 12 of the battery 10, because, with respect to the first variant embodiment, the accumulators whose charge state is in the vicinity of the maximum charge state are discharged simultaneously.

Moreover, the microcontroller 26 stops the charging cycle as soon as all the accumulators exhibit a charge state corresponding to a voltage lying between 3.6 V and 3.5 V, or when the charge state of all the accumulators ties between the maximum charge state and the higher charge state. Owing to this second comparator 26, the charging is stopped when it has become unnecessary.

We will now refer to FIG. 4, showing a second graph illustrating the progression of the charge state of four accumulators of the battery, which battery comprises ten accumulators, as a function of the charging cycles. It is then observed that the charging of the accumulators is relatively linear over the cycles, and especially that the maximum charge state of the accumulators under consideration is reached only after four operating cycles.

Thus, owing to the second comparator 36, well-defined stopping means are produced, which avoids having to lose energy by carrying out balancing when this is not necessary. In addition, the balancing is faster.

The algorithm for controlling the balancing may be more advanced. Nonetheless, it relies on the same principle of comparison of the voltage of the accumulators with a single threshold or two thresholds. The algorithm described above is more commonly referred to as “bang-bang control” “wide gain control” or else “sliding mode control”.

The balancing device described above is applicable to other components, such as capacitors.

1-12. (canceled)

13. A method for balancing an electrical accumulator battery, in which an electrical accumulator battery includes accumulators connected together in series and a charge current exhibiting a charging value charges the accumulators, the accumulators exhibiting a maximum charge state, the method comprising:
charging the accumulators during a charging to increase charge of the accumulators up to their maximum charge state,
wherein the charging comprises, in order:
a) feeding the accumulators in series with a charge current at a charging value until one of the accumulators of the battery reaches a maximum charge state;
b) during a coupling period, coupling the one of the accumulators to terminals of a corresponding discharging element to discharge the one of the accumulators, while the charge current is simultaneously lowered; and,
c) returning to a) after a time period less than or equal to the coupling period.

14. The balancing method as claimed in claim 13, wherein in b) the corresponding discharging element is passed through by a balancing current and the charge current is lowered to a value less than or equal to a balancing current.

15. The balancing method as claimed in claim 13, wherein the charge current is lowered to a nil value.

16. The balancing method as claimed in claim 13, wherein a higher charge state is defined, the higher charge state being below the maximum charge state, and, in b), the accumulators whose charge state lies between the higher charge state and the maximum charge state are coupled to corresponding discharging elements to discharge the accumulators.

17. The balancing method as claimed in claim 16, wherein in c), the process returns to a) if, and only if, at least one accumulator exhibits a charge state below the higher charge state.

18. The balancing method as claimed in claim 13, wherein the discharging element is a resistor.

19. A balancing device configured to charge an electrical accumulator battery, the electrical accumulator battery including accumulators connected together in series, the accumulators exhibiting a maximum charge state, the balancing device comprising:
charging means for providing a charge current exhibiting a charging value, the charge current to charge the accumulators during a charging to increase a charge of the accumulators up to their maximum charge state;
control means and monitoring means, for controlling the charging means so that the charging means feeds the accumulators in series with the charge current at the charging value until the monitoring means monitors one of the accumulators of the battery at its maximum charge state;
coupling means to be controlled by the control means to couple, during a coupling period, the one of the accumulators to terminals of a corresponding discharging element to discharge the one of the accumulators, while the control means simultaneously lowers the charge current; and
the control means is configured to control feeding of the accumulators with the charge current at the charging value, after a time period less than or equal to the coupling period.

20. The balancing device as claimed in claim 19, wherein the monitoring means comprises first monitoring means linked to the control means, for each of the accumulators.

21. The balancing device as claimed in claim 19, wherein the monitoring means further comprises second monitoring means for each of the accumulators, the second monitoring means configured to monitor a higher charge state, the higher charge state being below the maximum charge state.

22. The balancing device as claimed in claim 21, wherein the first and second monitoring means each include a comparator.

23. The balancing device as claimed in claim 19, wherein the coupling means comprises switches and discharging elements, for each of the accumulators, the switches being linked to the control means.

24. The balancing device as claimed in claim 19, wherein the discharging element is a resistor.
